(19) United States
(12) Patent Application Publication
(10) Pub. No.: US 2020/0037050 A1
(43) Pub. Date: Jan. 30, 2020

(54) Play Framework, Display Method, Apparatus and Storage Medium for Media Content

(71) Applicant: BEIJING YOUKU TECHNOLOGY CO., LTD., Beijing (CN)

(72) Inventors: Yu Wang, Hangzhou (CN); Jie Yan, Hangzhou (CN)

(73) Assignee: BEIJING YOUKU TECHNOLOGY CO., LTD.

(21) Appl. No.: 16/523,617

(22) Filed: Jul. 26, 2019

(30) Foreign Application Priority Data
Jul. 27, 2018 (CN) 201810847246.0

(51) Int. Cl. H04N 21/858; H04N 21/4788; H04N 21/431; H04N 21/433

(52) U.S. Cl. CPC H04N 21/8586; H04N 21/433; H04N 21/4312; H04N 21/4788

(57) ABSTRACT

A play framework, a display method, an apparatus, and a storage medium for media content are disclosed. The method includes: displaying a first media content through a player; obtaining a second media content, wherein the first media content belongs to a specified type of related content of the second media content; and displaying a hyperlink that points to the second media content. The present disclosure displays the hyperlink corresponding to the second media content in a play interface of the specified type of related content of the second media content, thus facilitating a user to view the second media content without the need of the user to manually search for the second media content.

### CROSS REFERENCE TO RELATED PATENT APPLICATIONS

This application claims priority to Chinese Patent Application No. 201810847246.0, filed on 27 Jul. 2018 and entitled “Play Framework, Display Method, Apparatus and Storage Medium for Media Content,” which is hereby incorporated by reference in its entirety.

### TECHNICAL FIELD

The present disclosure relates to the field of information technologies, and particularly, to play frameworks, display methods, apparatuses and storage media for media content.

### BACKGROUND

In media websites, correlations among some media content exist. For example, media content A is a segment of a media content B, or the media content A is a review content of the media content B, etc. How to display related media content in a play interface of a media content to facilitate users to view the related media content is an urgent problem to be solved.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure proposes play frameworks, display methods, apparatuses, and storage media for media content.

According to a first aspect of the present disclosure, a play framework of a media content is provided, which includes:

a media content information area used for displaying source and/or content information of a first media content;

a play area used for playing the first media content; and

a first interaction area used for jumping to display a second media content, wherein the first media content belongs to a specified type of related content of the second media content.

In implementations, the first interaction area is located inside the play area.

In implementations, the first interaction area is located outside the play area and is adjacent to the play area.

In implementations, the play framework further includes:

a control area used for collecting the second media content.

In implementations, the control area is located inside the first interaction area.

In implementations, the play framework further includes:

a second interaction area used for performing one or more of liking, commenting, tagging, and forwarding the first media content.

In implementations, the specified type of related content of the second media content includes one or more of: a segment of the second media content, a review content of the second media content, and a profile content of the second media content.

According to a second aspect of the present disclosure, a method for displaying media content is provided, which includes:

displaying a first media content through a player;

obtaining a second media content, wherein the first media content belongs to a specified type of related content of the second media content; and

displaying a hyperlink that points to the second media content.

In implementations, the method further includes:

displaying a control used for collecting the second media content in the hyperlink.

In implementations, the method further includes:

displaying a control used for performing one or more of liking, commenting, tagging, and forwarding the first media content.

In implementations, the specified type of related content of the second media content includes one or more of: a segment of the second media content, a review content of the second media content, and a profile content of the second media content.

According to a third aspect of the present disclosure, an apparatus for displaying media content is provided, which includes:

a first display module configured to display a first media content using a player;

an acquisition module configured to obtain a second media content, wherein the first media content belongs to a specified type of related content of the second media content; and

a second display module configured to display a hyperlink that points to the second media content.

In implementations, the apparatus further includes:

a third display module configured to display a control used for collecting the second media content in the hyperlink.

In implementations, the apparatus further includes:

a fourth display module configured to display a control for performing one or more of liking, commenting, tagging, and forwarding the first media content.

In implementations, the specified type of related content of the second media content includes one or more of: a segment of the second media content, a review content of the second media content, and a profile content of the second media content.

According to a fourth aspect of the present disclosure, a non-transitory computer readable storage medium is provided, which stores computer program instructions, the computer program instructions being executed by a processor to perform the method of the second aspect as described above.

According to a fifth aspect of the present disclosure, a method for recommending related media content is provided, which includes:

generating a play area, and embedding a player in the play area;

embedding a first code used for obtaining a first media content and being capable of playing in the player;

generating a first interaction area; and

embedding a second code used for jumping to display a second media content in the first interaction area, wherein the first media content belongs to a specified type of related content of the second media content.

In implementations, the first interaction area is located inside the play area.

In implementations, the first interaction area is located outside the play area and is adjacent to the play area.

In implementations, the method further includes:

generating a control area; and

embedding a third code used for collecting the second media content in the control area.

In implementations, the control area is located inside the first interaction area.

In implementations, the method further includes:

generating a second interaction area;

embedding a fourth code used for performing one or more of: liking, commenting, tagging, and forwarding the first media content in the second interaction area.

In implementations, the specified type of related content of the second media content includes one or more of: a segment of the second media content, a review content of the second media content, and a profile content of the second media content.

According to a sixth aspect of the present disclosure, an apparatus for recommending related media content is provided, which includes:

a first generation module configured to generate a play area, and embed a player in the play area;

a first embedding module configured to embed a first code used for obtaining a first media content and being capable of playing in the player;

a second generation module configured to generate a first interaction area; and

a second embedding module configured to embed a second code used for jumping to display a second media content in the first interaction area, wherein the first media content belongs to a specified type of related content of the second media content.

In implementations, the first interaction area is located inside the play area.

In implementations, the first interaction area is located outside the play area and is adjacent to the play area.

In implementations, the apparatus further includes:

a third generation module configured to generate a control area; and

a third embedding module configured to embed a third code used for collecting the second media content in the control area.

In implementations, the control area is located inside the first interaction area.

In implementations, the apparatus further includes:

a fourth generation module configured to generate a second interaction area; and

a fourth embedding module configured to embed a fourth code used for performing one or more of: liking, commenting, tagging, and forwarding the first media content in the second interaction area.

In implementations, the specified type of related content of the second media content includes one or more of: a segment of the second media content, a review content of the second media content, and a profile content of the second media content.

According to a seventh aspect of the present disclosure, a non-transitory computer readable storage medium is provided, which stores computer program instructions that, when executed by a processor, implement the method of the fifth aspect as described above.

The methods for displaying media content according to various aspects of the present disclosure obtain a second media content by displaying a first media content through a player, wherein the first media content belongs to a specified type of related content of the second media content, and displays a hyperlink that points to the second media content, thereby displaying the hyperlink corresponding to the second media content in a play interface of the specified type of related content of the second media content, and facilitating a user to view the second media content without the need of the user to manually search for the second media content.

Exemplary embodiments are described in detail by referencing to accompanying drawings as follows, and other features and aspects of the present disclosure will become apparent.

### BRIEF DESCRIPTION OF THE DRAWINGS

Accompanying drawings which are included in and constitute a part of the specification illustrate exemplary embodiments, features and aspects of the present disclosure in conjunction with the specification, and are used for describing the principles of the present disclosure.

FIG. 1 illustrates an exemplary framework diagram of a play framework of a media content in accordance with an embodiment of the present disclosure.

FIG. 2 illustrates a schematic diagram of a play framework of a media content in accordance with an embodiment of the present disclosure.

FIG. 3 illustrates another exemplary framework diagram of a play framework of a media content in accordance with an embodiment of the present disclosure.

FIG. 4 illustrates another schematic diagram of a play framework of a media content in accordance with an embodiment of the present disclosure.

FIG. 5 illustrates a flowchart of a method of displaying media content in accordance with an embodiment of the present disclosure.

FIG. 6 illustrates an exemplary flowchart of a method of displaying media content according to an embodiment of the present disclosure.

FIG. 7 illustrates a block diagram of a display apparatus of a media content in accordance with an embodiment of the present disclosure.

FIG. 8 illustrates an exemplary block diagram of a display apparatus of a media content in accordance with an embodiment of the present disclosure.

FIG. 9 illustrates a flowchart of a method for recommending related media content in accordance with an embodiment of the present disclosure.

FIG. 10 illustrates an exemplary flowchart of a method for recommending related media content in accordance with an embodiment of the present disclosure.

FIG. 11 illustrates a block diagram of an apparatus for recommending related media content in accordance with an embodiment of the present disclosure.

FIG. 12 illustrates an exemplary block diagram of an apparatus for recommending related media content in accordance with an embodiment of the present disclosure.

FIG. 13 is a block diagram of an apparatus 800 for displaying media content or recommending related media content in accordance with an exemplary embodiment.

### DETAILED DESCRIPTION

Various exemplary embodiments, features, and aspects of the present disclosure are described in detail hereinafter with reference to the accompanying drawings. The same reference numerals in the drawings denote the same or similar elements. Although various aspects of the embodiments are illustrated in the accompanying drawings, the accompanying drawings are not necessarily drawn to scale unless indicated otherwise.

The word “exemplary” is used exclusively herein to mean “serving as an example, embodiment, or illustration.” Any embodiment described herein as “exemplary” is not necessarily to be construed as being preferred or better as compared to other embodiments.

In addition, a number of specific details are set forth in the Detailed Description as follows. One skilled in the art should understand that the present disclosure may be practiced without certain specific details. In some instances, methods, means, components, and circuits that are well known to one skilled in the art are not described in detail in order to emphasize the purpose of the present disclosure.

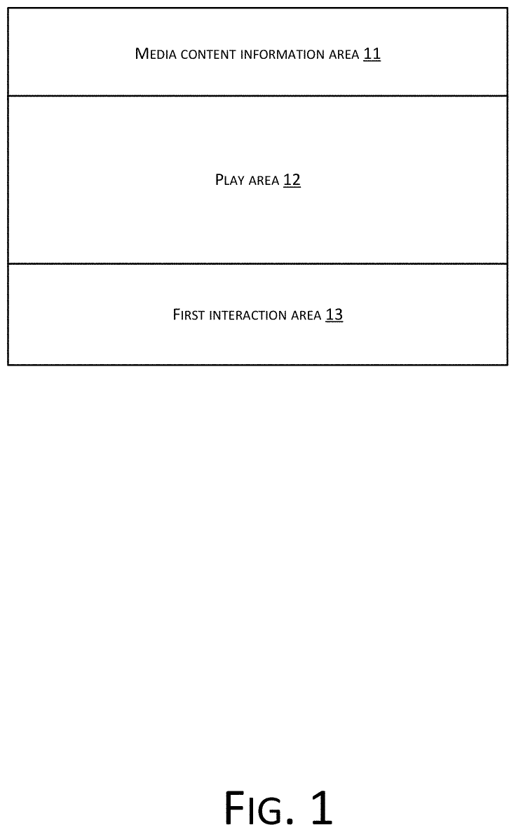

FIG. 1 illustrates an exemplary frame diagram of a play framework of a media content in accordance with an embodiment of the present disclosure. As shown in FIG. 1, the play framework of the media content includes a media content information area 11, a play area 12, and a first interaction area 13. The media content information area 11 is used for displaying source and/or content information of a first media content. The play area 12 is used for playing the first media content. The first interaction area 13 is used for jumping to display a second medium content, wherein the first media content belongs to a specified type of related content of the second media content.

In the embodiments of the present disclosure, the first media content may be a video or an audio, etc., which is not limited herein.

In implementations, the media content information area 11 is located outside the play area 12.

As an example of this implementation, the media content information area 11 may be located above the play area 12.

As another example of this implementation, the media content information area 11 may be located below the play area 12.

In other examples of the implementation, the media content information area 11 may also be located at the left or right hand side of the play area 12, etc., which is not limited herein.

In another possible implementation, the media content information area 11 is located inside the play area 12.

As an example of this implementation, the media content information area 11 may be located at the top portion of the play area 12.

As another example of this implementation, the media content information area 11 may be located at the bottom portion of the play area 12.

In other examples of this implementation, the media content information area 11 may also be located at the left or right portion of the play area 12, etc., which is not limited herein.

In implementations, the source information of the first media content may include an author of the first media content or a party that uploads the first media content, etc.

In implementations, the content information of the first media content may include a title of the first media content.

In implementations, the first interaction area 13 is located inside the play area 12.

As an example of this implementation, the first interaction area 13 can be located at the top portion of the play area 12. For example, the first interaction area 13 may be located above the media content information area 11 and be adjacent to the media content information area 11. As another example, the first interaction area 13 may be located below the media content information area 11 and be adjacent to the media content information area 11.

As another example of this implementation, the first interaction area 13 can be located at the bottom portion of the play area 12. For example, the first interaction area 13 may be located above the media content information area 11 and be adjacent to the media content information area 11. As another example, the first interaction area 13 may be located below the media content information area 11 and be adjacent to the media content information area 11.

In other examples of this implementation, the first interaction area 13 may also be located at the left or right portion of the play area 12, etc., which is not limited herein.

In another possible implementation, the first interaction area 13 is located outside the play area 12 and is adjacent to the play area.

As an example of this implementation, the first interaction area 13 is located above the play area 12 and is adjacent to the play area.

As another example of this implementation, the first interaction area 13 is located below the play area 12 and is adjacent to the play area.

The embodiments of the present disclosure can facilitate a user to view a second media content by displaying a first interaction area used for jumping to display the second media content in a play interface of a specified type of related content of the second media content, without the need of a user to manually search for the second media content.

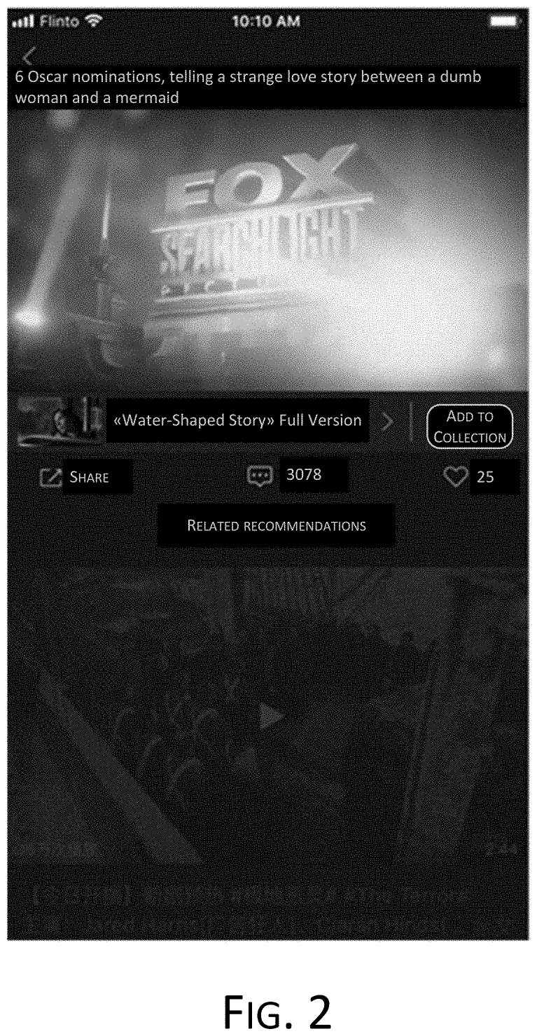

FIG. 2 illustrates a schematic diagram of a play framework of a media content in accordance with an embodiment of the present disclosure. In the example as shown in FIG. 2, the media content information area 11 displays “6 Oscar nominations, telling a strange love story between a dumb woman and a mermaid”, and the media content information area 11 is located above the play area 12. The first interaction area 13 displays a text of “Full version of «Water-Shaped Story»”, and the first interaction area 13 is located below the play area 12. In the example as shown in FIG. 2, the first media content is a review content of the second media content.

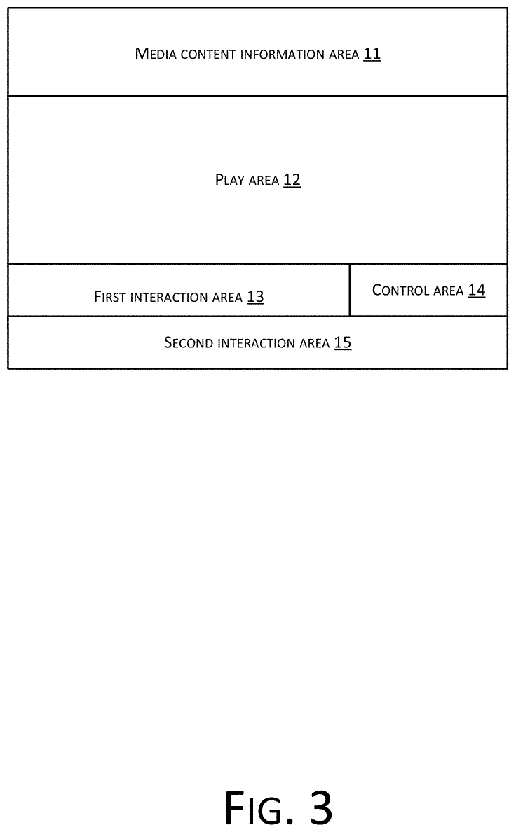

FIG. 3 illustrates another exemplary framework diagram of a play framework of a media content in accordance with an embodiment of the present disclosure. In implementations, the play framework further includes: a control area 14 used for collecting the second media content.

In implementations, the control area 14 is located inside the first interaction area 13. For example, in the examples shown in FIGS. 2 and 3, the control area 14 is located inside the first interaction area 13.

In implementations, the play framework further includes: a second interaction area 15 used for performing one or more of: liking, commenting, tagging, and forwarding the first media content.

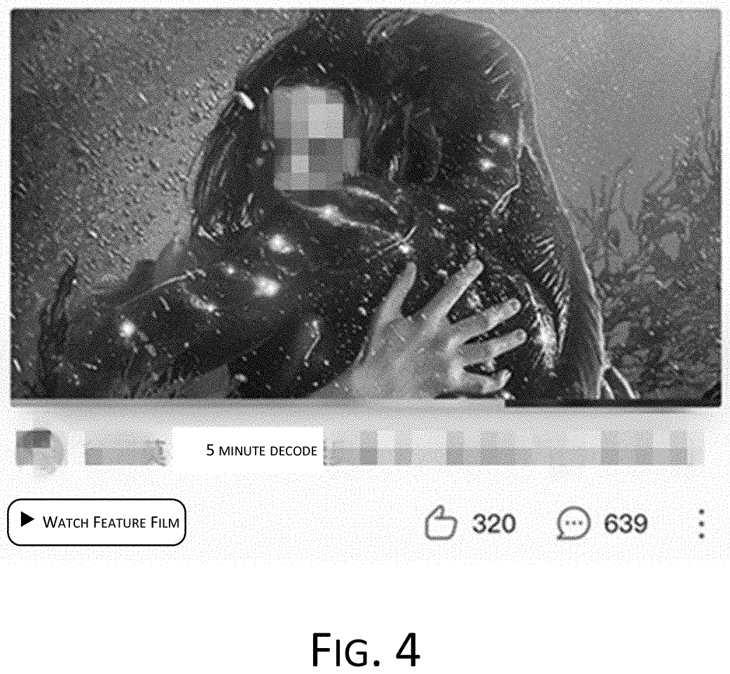

FIG. 4 illustrates another schematic diagram of a play framework of a media content in accordance with an embodiment of the present disclosure. In the example shown in FIG. 4, the first media content is a profile content of the second media content.

In implementations, the specified type of related content of the second media content includes one or more of: a segment of the second media content, a review content of the second media content, and a profile content of the second media content. For example, if the second media content is a video, the specified type of related content of the second media content may include one or more of: a video segment of the second media content, a video review of the second media content, and a profile content of the second media content.

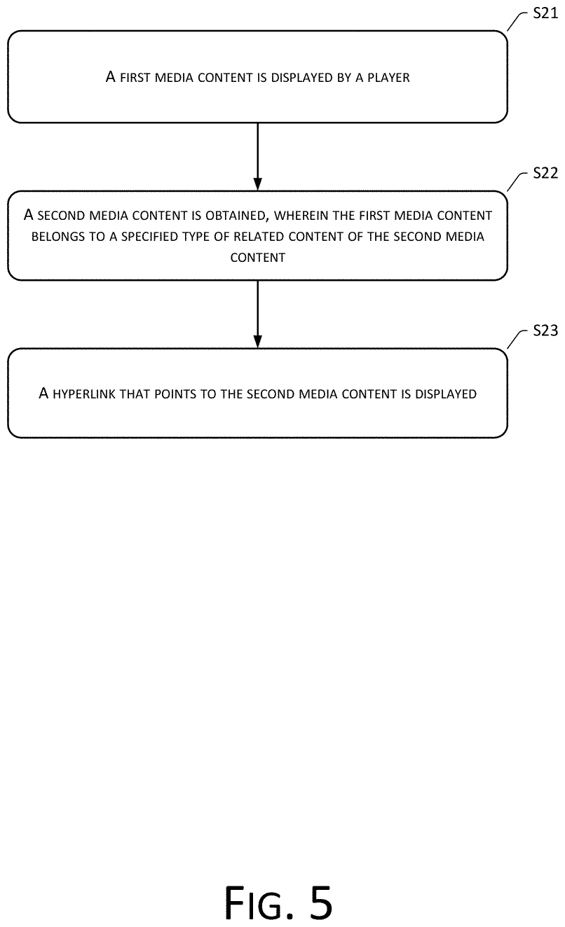

FIG. 5 illustrates a flowchart of a method of displaying media content in accordance with an embodiment of the present disclosure. As shown in FIG. 5, the method includes steps S21 to S23.

At step S21, a first media content is displayed by a player.

At step S22, a second media content is obtained, wherein the first media content belongs to a specified type of related content of the second media content.

At step S23, a hyperlink that points to the second media content is displayed.

In implementations, a text of the hyperlink that points to the second media content may be determined according to one or both of a title and a descriptive text of the second media content.

For example, the descriptive text is “Watch Feature Film”, or “Full version”.

As an example of this implementation, the text of the hyperlink that points to the second media content may be determined based on the title of the second media content.

As another example of this implementation, the text of the hyperlink that points to the second media content may be determined based on the descriptive text. For example, in the example shown in FIG. 4, according to the descriptive text “Watch Feature Film”, the text of the hyperlink that points to the second media content is determined to be “Watch Feature Film”.

As another example of this implementation, the text of the hyperlink that points to the second media content may be determined based on a title and a descriptive text of a second video. For example, in the example shown in FIG. 2, according to the title “Water-Shaped Story” of the second media content and the descriptive text “Full version”, the text of the hyperlink that points to the second media content is determined to be “«Water-Shaped Story» Full Version”

In implementations, the method further includes: obtaining a descriptive text of the second media content relative to the first media content according to a type of the related content that the first media content belongs to the second media content.

For example, if the type of the related content of the first media content belonging to the second media content is a segment, the descriptive text of the second media content relative to the first media content is a “Full version”.

For another example, if the type of the related content of the first media content belonging to the second media content is a review content or a profile content, the descriptive text of the second media content relative to the first media content is ““Watch Feature Film”.

In implementations, the hyperlink that points to the second media content further includes a key image corresponding to the second media content. For example, in the example shown in FIG. 2, the hyperlink that points to the second media content further includes a key image corresponding to the second media content.

As an example of this implementation, the key image corresponding to the second media content is one of a poster, a stage photo, and a cover of the second media content.

The method for displaying media content of the embodiments of the present disclosure displays a first media content through a player, obtains a second media content, wherein the first media content belongs to a specified type of related content of the second media content, and displays a hyperlink pointing to the second media content, thereby displaying a hyperlink corresponding to the second media content in a play interface of the specified type of related content of the second media content, and thus facilitating a user to view the second media content without the need of the user to manually search for the second media content.

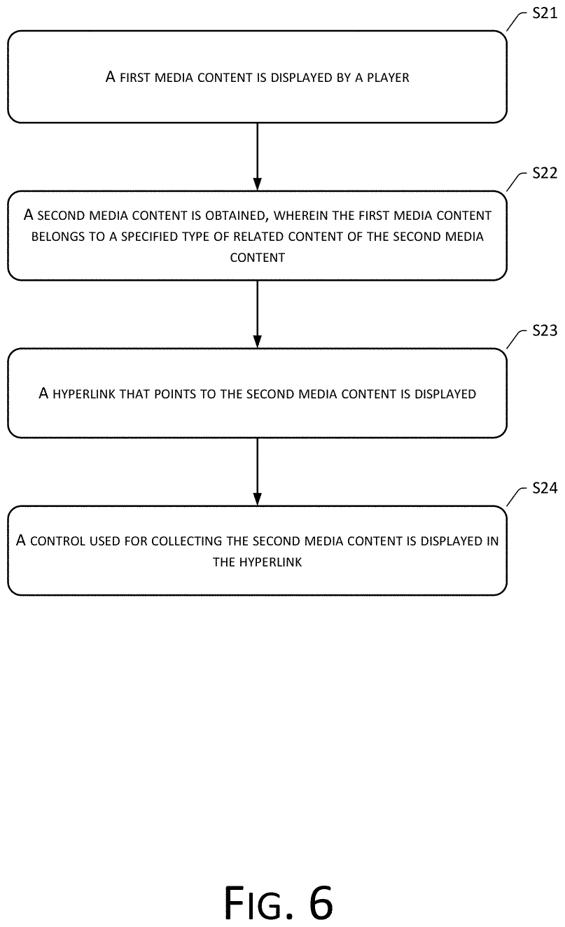

FIG. 6 illustrates an exemplary flowchart of a method of displaying media content according to an embodiment of the present disclosure. As shown in FIG. 6, the method may include steps S21 to S24.

At step S21, a first media content is displayed through a player.

At step S22, a second media content is obtained, wherein the first media content belongs to a specified type of related content of the second media content.

At step S23, a hyperlink pointing to the second media content is displayed.

At step S24, a control used for collecting the second media content is displayed in the hyperlink.

This example displays a control used for collecting the second media content through the hyperlink, thereby facilitating a user to collect the second media content in a play interface of the first media content without interrupting the user from viewing the first media content.

In implementations, the method further includes: displaying a control used for performing one or more of: liking, commenting, tagging, and forwarding the first media content.

In implementations, the specified type of related content of the second media content includes one or more of: a segment of the second media content, a review content of the second media content, and a profile content of the second media content.

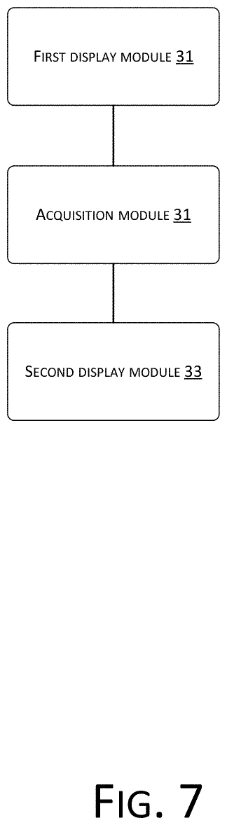

FIG. 7 illustrates a block diagram of a display apparatus for a media content in accordance with an embodiment of the present disclosure. As shown in FIG. 7, the apparatus includes: a first display module 31 configured to display a first media content through a player; and an acquisition module 32 configured to obtain a second media content, wherein the first media content belongs to a specified type of related content of the second media content; and the second display module 33 is configured to display a hyperlink to the second media content.

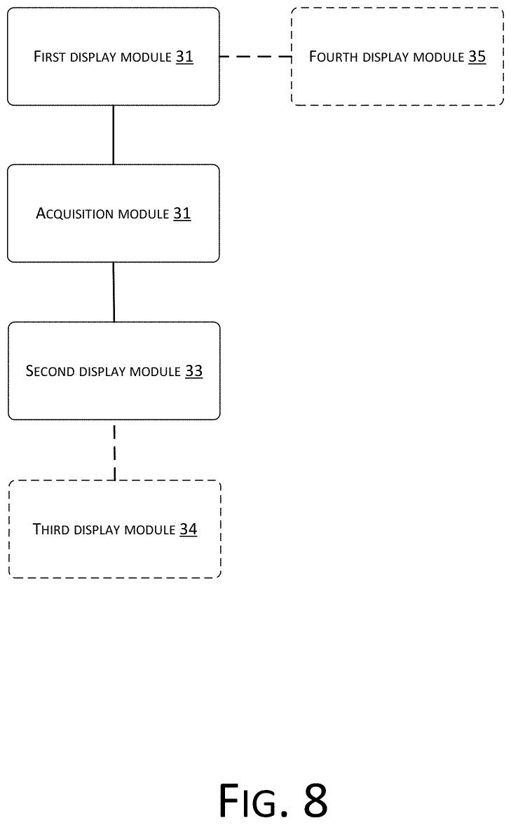

FIG. 8 illustrates an exemplary block diagram of a display apparatus for a media content in accordance with an embodiment of the present disclosure. As shown in FIG. 8:

In implementations, the apparatus further includes: a third display module 34 configured to display a control used for collecting the second media content in a hyperlink.

In implementations, the apparatus further includes: a fourth display module 35 configured to display a control used for performing one or more of: liking, commenting, tagging, and forwarding the first media content.

In implementations, the specified type of related content of the second media content includes one or more of: a segment of the second media content, a review content of the second media content, and a profile content of the second media content.

The method for displaying media content of the embodiments of the present disclosure displays a first media content through player, obtains a second media content, wherein the first media content belongs to a specified type of related content of the second media content, and displays a hyperlink pointing to the second media content, thereby displaying the hyperlink corresponding to the second media content in a play interface of the specified type of related content of the second media content, and thus facilitating a user to view the second media content without the need of the user to manually search for the second media content.

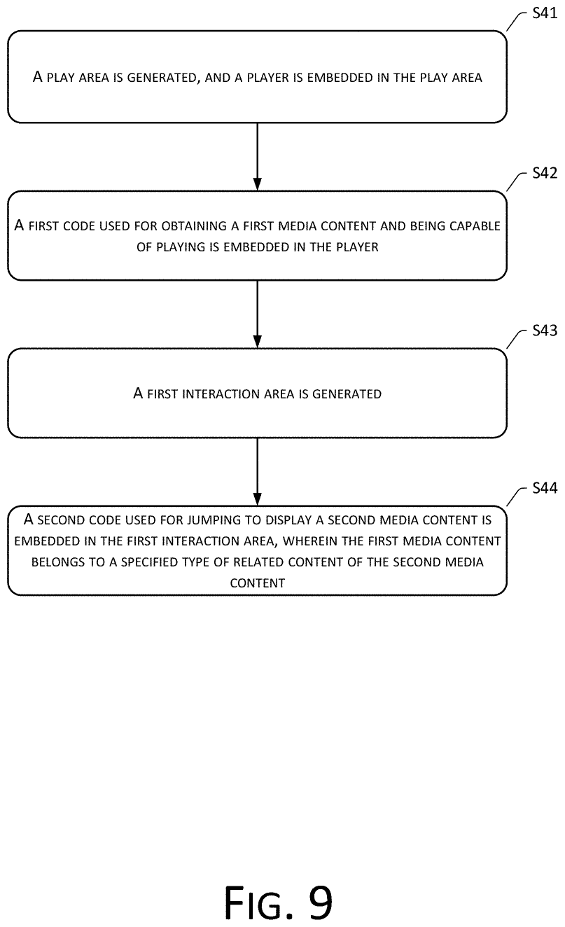

FIG. 9 illustrates a flowchart of a method for recommending related media content in accordance with an embodiment of the present disclosure. As shown in FIG. 9, the method includes steps S41 to S44.

At step S41, a play area is generated, and a player is embedded in the play area.

At step S42, a first code used for obtaining a first media content and being capable of playing is embedded in the player.

At step S43, a first interaction area is generated.

At step S44, a second code used for jumping to display a second media content is embedded in the first interaction area, wherein the first media content belongs to a specified type of related content of the second media content.

In implementations, the first interaction area is located inside the play area.

In implementations, the first interaction area is located outside the play area and is adjacent to the play area.

The embodiments of the present disclosure generate a play area, embed a player in the play area, embed a first code used for obtaining a first media content and being capable of playing in the player, generate a first interaction area, and embed a second code used for jumping to display a second media content in the first interaction area, wherein the first media content belongs to a specified type of related content of the second media content, thereby enabling displaying a hyperlink used for jumping to the second media content in a play interface of the specified type of related content of the second media content, so that a user can view the second media content without the need of the user to manually search for the second media content.

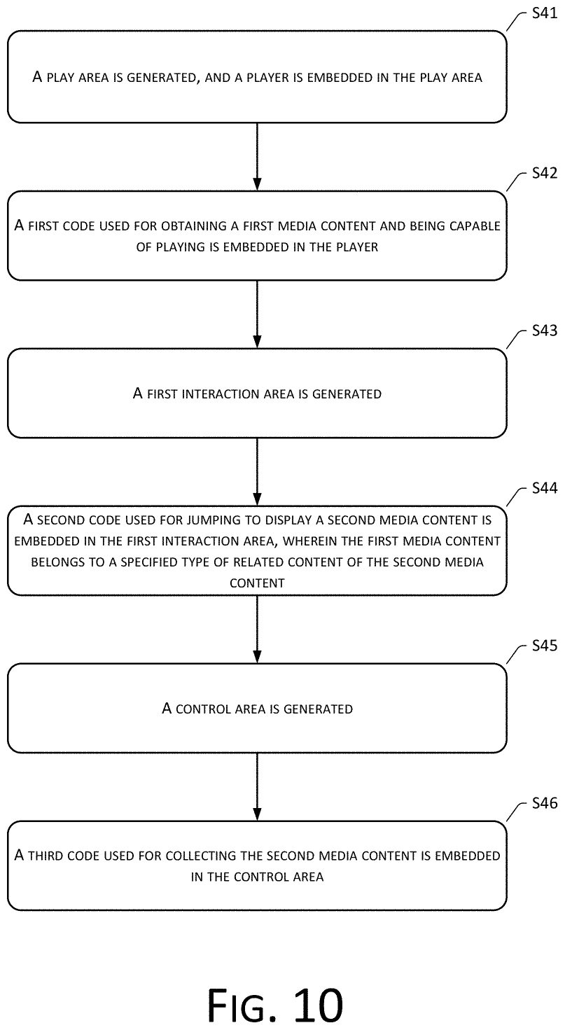

FIG. 10 illustrates an exemplary flowchart of a method for recommending related media content in accordance with an embodiment of the present disclosure. As shown in FIG. 10, the method may include steps S41 to S46.

At step S41, a play area is generated, and a player is embedded in the play area.

At step S42, a first code used for obtaining a first media content and being capable of playing is embedded in the player.

At step S43, a first interaction area is generated.

At step S44, a second code used for jumping to display a second media content is embedded in the first interaction area, wherein the first media content belongs to a specified type of related content of the second media content.

At step S45, a control area is generated.

At step S46, a third code used for collecting the second media content is embedded in the control area.

This example generates a control area and embeds a third code used for collecting the second media content in the control area, thereby facilitating the user to collect the second media content in the play interface of the first media content without interrupting the user from viewing the first media content.

In implementations, the control area is located inside the first interaction area.

In implementations, the method further includes: generating a second interaction area; embedding a fourth code used for performing one or more of: liking, commenting, tagging, and forwarding the first media content.

In implementations, the specified type of related content the second media content includes one or more of: a segment of the second media content, a review content of the second media content, and a profile content of the second media content.

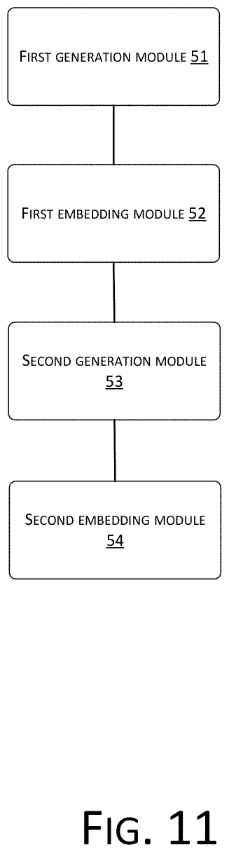

FIG. 11 shows a block diagram of an apparatus for recommending related media content in accordance with an embodiment of the present disclosure. As shown in FIG. 11, the apparatus includes: a first generation module 51 configured to generate a play area, and embed a player in the play area; a first embedding module 52 configured to embed a first code for obtaining a first media content and being capable of playing in the player; a second generation module 53 configured to generate a first interaction area; and a second embedding module 54 configured to embed a second code used for jumping to display a second media content in the first interaction area, wherein the first media content belongs to a specified type of related content of the second media content.

In implementations, the first interaction area is located inside the play area.

In implementations, the first interaction area is located outside the play area and is adjacent to the play area.

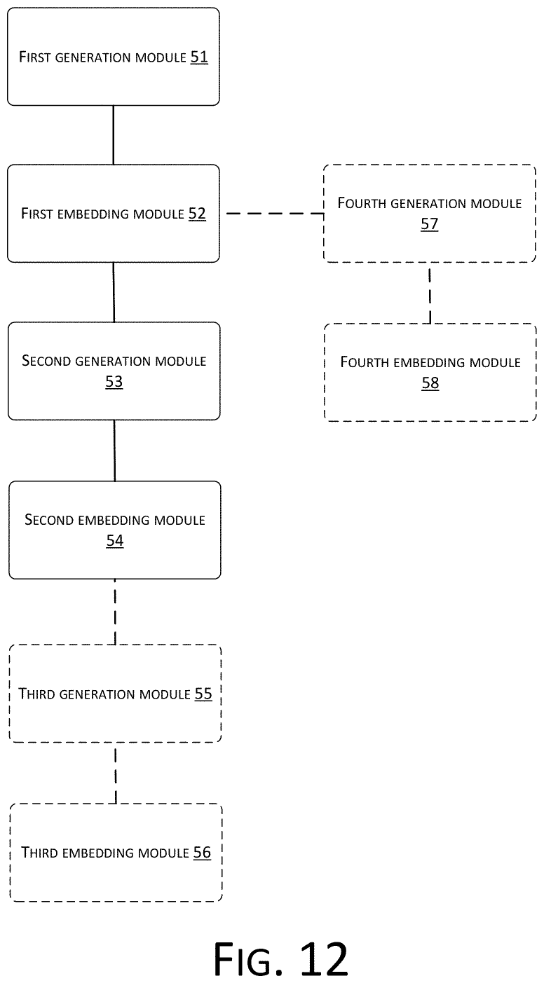

FIG. 12 illustrates an exemplary block diagram of an apparatus for recommending related media content in accordance with an embodiment of the present disclosure. As shown in FIG. 12:

In implementations, the apparatus further includes: a third generation module 55 configured to generate a control area; and a third embedding module 56 configured to embed a third code used for collecting the second media content in the control area.

In implementations, the control area is located inside the first interaction area.

In implementations, the apparatus further includes: a fourth generation module 57 configured to generate a second interaction area; and a fourth embedding module 58 configured to embed a fourth code used for performing one or more of: liking, commenting, tagging, and forwarding the first media content in the second interaction area.

In implementations, the specified type of related content of the second media content includes one or more of: a segment of the second media content, a review content of the second media content, and a profile content of the second media content.

The embodiments of the present disclosure generate a play area, embed a player in the play area, embed a first code used for obtaining a first media content and being capable of playing in the player, generate a first interaction area, and embed a second code used for jumping to display a second media content in the first interaction area, wherein the first media content belongs to a specified type of related content of the second media content, thereby enabling displaying a hyperlink used for jumping to the second media content is displayed in a play interface of the specified type of related content of the second media content, so that a user can view the second media content without the need of the user to manually search for the second media content.

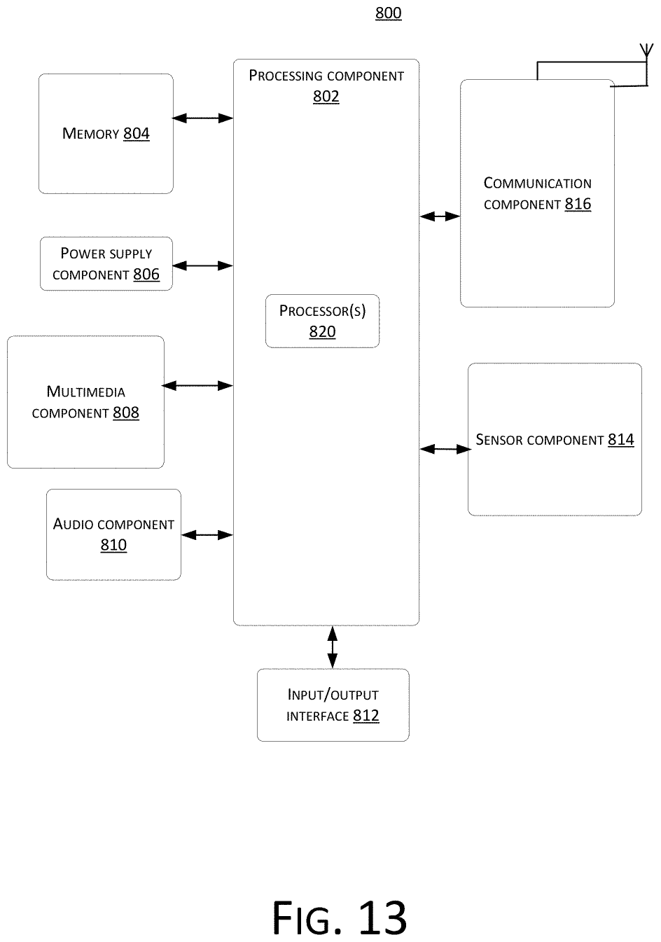

FIG. 13 is a block diagram of an apparatus 800 for displaying a media content or recommending a related media content in accordance with an exemplary embodiment. For example, the apparatus 800 can be a mobile phone, a computer, a digital broadcasting terminal, an information sending and receiving device, a gaming console, a tablet device, a medical device, a fitness device, a personal digital assistant, and the like.

Referring to FIG. 13, the apparatus 800 can include one or more of the following components: a processing component 802, a memory 804, a power supply component 806, a multimedia component 808, an audio component 810, an input/output (I/O) interface 812, a sensor component 814, and a communication component 816.

The processing component 802 typically controls overall operations of the apparatus 800, such as operations associated with display, telephone calls, data communications, camera operations, and recording operations. The processing component 802 can include one or more processors 820 to execute instructions to perform all or part of the steps of the methods described above. Moreover, the processing component 802 can include one or more modules to facilitate interactions between the component 802 and other components. For example, the processing component 802 can include a multimedia module to facilitate interactions between the multimedia component 808 and the processing component 802.

The memory 804 is configured to store various types of data to support operations in the apparatus 800. Examples of such data include instructions used for any application programs or methods operating on the apparatus 800, contact data, phonebook data, messages, pictures, videos, and the like. The memory 804 can be implemented by any type of volatile or non-volatile storage devices, or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power supply component 806 provides power to various components of the apparatus 800. The power component 806 can include a power management system, one or more power sources, and other components associated with generating, managing, and distributing power for the apparatus 800.

The multimedia component 808 includes a screen that provides an output interface between the apparatus 800 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, slides, and gestures on the touch panel. The touch sensor(s) may sense not only the boundary of a touching or sliding action, but also the duration and pressure associated with the touching or sliding action. In some embodiments, the multimedia component 808 includes a front camera and/or a rear camera. When the apparatus 800 is in an operation mode, such as a shooting mode or a video mode, the front camera and/or the rear camera can receive external multimedia data. Each of the front camera and the rear camera can be a fixed optical lens system or have focal length and optical zooming capabilities.

The audio component 810 is configured to output and/or input an audio signal. For example, the audio component 810 includes a microphone (MIC). The microphone is configured to receive an external audio signal when the apparatus 800 is in an operational mode, such as a call mode, a recording mode, and a voice recognition mode. The received audio signal may further be stored in the memory 804 or transmitted via the communication component 816. In some embodiments, the audio component 810 also includes a speaker used for outputting an audio signal.

The I/O interface 812 provides an interface between the processing component 802 and a peripheral interface module, which may be a keyboard, a click wheel, a button, etc. These buttons may include, but are not limited to, a home button, a volume button, a start button, and a lock button.

The sensor component 814 includes one or more sensors for providing various aspects of status assessments to the apparatus 800. For example, the sensor component 814 can detect an open/closed status of the apparatus 800, relative positioning between components, such as a display and a keypad of the apparatus 800. The sensor component 814 can also detect a change in position of the apparatus 800 or a component of the apparatus 800, a presence or absence of user contact with the apparatus 800, an orientation or acceleration/deceleration of the apparatus 800, and a change in temperature of the apparatus 800. The sensor component 814 can include a proximity sensor configured to detect a presence of nearby object(s) without any physical contact. The sensor component 814 may also include a light sensor, such as a CMOS or CCD image sensor, for use in imaging applications. In some embodiments, the sensor component 814 can also include an acceleration sensor, a gyroscope sensor, a magnetic sensor, a pressure sensor, or a temperature sensor.

The communication component 816 is configured to facilitate wired or wireless communications between the apparatus 800 and other devices. The apparatus 800 can access a wireless network based on a communication standard, such as WiFi, 2G or 3G, or a combination thereof. In an exemplary embodiment, the communication component 816 receives broadcast signals or broadcast-related information from an external broadcast management system via a broadcasting channel. In an exemplary embodiment, the communication component 816 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology, and other technologies.

In an exemplary embodiment, the apparatus 800 may be implemented by one or more application specific integrated circuits (ASICs), digital signal processors (DSPs), digital signal processing devices (DSPDs), programmable logic devices (PLDs), field programmable gate array (FPGAs), controllers, microcontrollers, microprocessors, or other electronic components for performing the above methods.

In an exemplary embodiment, a non-transitory computer readable storage medium is also provided, such as the memory 804 that includes computer program instructions. The computer program instructions can be executed by the processor 820 of the apparatus 800 to perform the above methods.

The present disclosure can be a system, a method, and/or a computer program product. The computer program product can include a computer readable storage medium having computer readable program instructions embodied thereon to cause processor(s) to implement various aspects of the present disclosure.

The computer readable storage medium can be a tangible device that can maintain and store instructions used by an instruction execution device. The computer readable storage medium can be, for example, but is not limited to, an electrical storage device, a magnetic storage device, an optical storage device, an electromagnetic storage device, a semiconductor storage device, or any suitable combination of the foregoing. More specific examples (a non-exhaustive list) of computer readable storage media include: a portable computer disk, a hard disk, a random access memory (RAM), a read only memory (ROM), an erasable programmable read only memory (EPROM) or flash memory), a static random access memory (SRAM), a portable compact disk read only memory (CD-ROM), a digital versatile disk (DVD), a memory stick, a floppy disk, a mechanical encoding device, for example, a hole card or raised structures in grooves having instructions stored thereon, and any suitable combination of the foregoing. A computer readable storage medium that is used herein is not to be interpreted as a transient signal itself, such as a radio wave or other freely propagating electromagnetic wave, an electromagnetic wave propagating through a waveguide or other transmission medium (e.g., a light pulse through a fiber optic cable), or an electrical signal transmitted through a wire.

Computer readable program instructions described herein can be downloaded from a computer readable storage medium to various computing/processing devices or downloaded to external computers or external storage devices through a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives computer readable program instructions through a network and forwards the computer readable program instructions to allow storage in a computer readable storage medium in each computing/processing device.

Computer program instructions used for performing operations of the present disclosure may be assembly instructions, instruction set architecture (ISA) instructions, machine instructions, machine-related instructions, microcode, firmware instructions, state configuration data, or source codes or object codes written in any combination of one or more programming languages. The programming languages include object-oriented programming languages such as Smalltalk, C++, etc., as well as conventional procedural programming languages such as the “C” language or similar programming languages. The computer readable program instructions can be executed entirely on a user's computer, executed partly on a user's computer, executed as a stand-alone software package, executed partly on a user's computer and partly on a remote computer, or entirely on a remote computer or server. When a remote computer is involved, the remote computer can be connected to a user's computer through any type of network, including a local area network (LAN) or a wide area network (WAN), or can be connected to an external computer (e.g., connected through the Internet using an Internet service provider). In some embodiments, state information of computer readable program instructions can be used to customize an electronic circuit, such as a programmable logic circuit, a field programmable gate array (FPGA), or a programmable logic array (PLA). Such electronic circuit can execute the computer readable program instructions to implement various aspects of the present disclosure.

Aspects of the present disclosure are described herein with reference to flowcharts and/or block diagrams of methods, apparatus, and computer program products according to the embodiments of the present disclosure. It should be understood that each block of the flowcharts and/or block diagrams, and each combination of blocks in the flowcharts and/or block diagrams can be implemented by computer readable program instructions.

These computer readable program instructions can be provided to a general purpose computer, a special purpose computer, or a processor of other programmable data processing apparatus to produce a machine, such that these instructions implement functions/acts specified in one or more of the blocks of the flowcharts and/or block diagrams when being executed by a processor of a computer or other programmable data processing apparatus. The computer readable program instructions can also be stored in a computer readable storage medium. The computer readable program instructions cause a computer, programmable data processing device, and/or other device to operate in a particular manner, such that the computer readable medium storing the instructions includes an article of manufacture, and includes instructions for implementing various aspects of the functions/acts specified in one or more of the blocks of the flowcharts and/or block diagrams.

The computer readable program instructions can also be loaded onto a computer, other programmable data processing device, or other device to perform a series of operational steps on the computer, the other programmable data processing device or the other device to produce a computer-implemented process. As such, the instructions executed on the computer, the other programmable data processing apparatus, or the other device implement the functions/acts specified in one or more of the blocks in the flowcharts and/or block diagrams.

The flowchart and block diagrams in the accompanying drawings illustrate the architecture, functionalities and operations of possible implementations of systems, methods and computer program products according to various embodiments of the present disclosure. In this regard, each block in a flowchart or block diagram can represent a module, a program segment, or a portion of an instruction. The module, the program segment, or the portion of the instruction includes one or more executable instructions used for implementing specified logical function(s). In some alternative implementations, functions noted in the blocks may also occur in an order different from those illustrated in the drawings. For example, two consecutive blocks may be executed substantially in parallel, and may sometimes be executed in a reverse order, depending upon functions that are involved. It is also noted that each block of the block diagrams and/or flowcharts, and combinations of blocks in the block diagrams and/or flowcharts can be implemented in a dedicated hardware-based system that performs specified functions or actions, or can be implemented by a combination of dedicated hardware and computer instructions.

The embodiments of the present disclosure have been described above. The foregoing description is illustrative, not limiting, and not limited to the disclosed embodiments. A number of modifications and changes are apparent to one skilled in the art without departing from the scope and spirit of various embodiments of the present specification. The choice of terms used herein is intended to best explain the principles of the embodiments, practical applications, or technical improvements to the technical fields, or enable other ordinary skill in the art to understand the embodiments disclosed herein.

The present disclosure can be further understood using the following clauses.

Clause 1: A play framework of a media content, comprising: a media content information area used for displaying source and/or content information of a first media content; a play area used for playing the first media content; and a first interaction area used for jumping to display a second media content, wherein the first media content belongs to a specified type of related content of the second media content.

Clause 2: The play framework of Clause 1, wherein the first interaction area is located inside the play area.

Clause 3: The play framework of Clause 1, wherein the first interaction area is located outside the play area and is adjacent to the play area.

Clause 4: The play framework of Clause 1, further comprising: a control area used for collecting the second media content.

Clause 5: The play framework of Clause 1, wherein the control area is located inside the first interaction area.

Clause 6: The play framework of any one of Clauses 1-5, further comprising: a second interaction area used for performing one or more of liking, commenting, tagging, and forwarding the first media content.

Clause 7: The play framework of any one of Clauses 1-5, wherein the specified type of related content of the second media content comprises one or more of: a segment of the second media content, a review content of the second media content, and a profile content of the second media content.

Clause 8: A method for displaying media content, comprising: displaying a first media content through a player; obtaining a second media content, wherein the first media content belongs to a specified type of related content of the second media content; and displaying a hyperlink that points to the second media content.

Clause 9: The method of Clause 8, further comprising: displaying a control used for collecting the second media content in the hyperlink.

Clause 10: The method of Clause 8 or 9, further comprising: displaying a control used for performing one or more of liking, commenting, tagging, and forwarding the first media content.

Clause 11: The method of Clause 8 or 9, wherein the specified type of related content of the second media content comprises one or more of: a segment of the second media content, a review content of the second media content, and a profile content of the second media content.

Clause 12: An apparatus for displaying media content, comprising: a first display module configured to display a first media content using a player; an acquisition module configured to obtain a second media content, wherein the first media content belongs to a specified type of related content of the second media content; and a second display module configured to display a hyperlink that points to the second media content.

Clause 13: The apparatus of Clause 12, further comprising: a third display module configured to display a control Clause for collecting the second media content in the hyperlink.

Clause 14: The apparatus of claim 12 or 13, further comprising: a fourth display module configured to display a control for performing one or more of liking, commenting, tagging, and forwarding the first media content.

Clause 15: The apparatus of Clause 12 or 13, wherein the specified type of related content of the second media content comprises one or more of: a segment of the second media content, a review content of the second media content, and a profile content of the second media content.

Clause 16: A non-transitory computer readable storage medium storing computer program instructions, wherein the computer program instructions, when executed by a processor, implement the method of any one of Clauses 8-11.

Clause 17: A method for recommending related media content, comprising: generating a play area, and embedding a player in the play area; embedding a first code used for obtaining a first media content and being capable of playing in the player; generating a first interaction area; and embedding a second code used for jumping to display a second media content in the first interaction area, wherein the first media content belongs to a specified type of related content of the second media content.

Clause 18: The method of Clause 17, wherein the first interaction area is located inside the play area.

Clause 19: The method of Clause 17, wherein the first interaction area is located outside the play area and is adjacent to the play area.

Clause 20: The method of Clause 17, further comprising: generating a control area; and embedding a third code used for collecting the second media content in the control area.

Clause 21: The method of Clause 20, wherein the control area is located inside the first interaction area.

Clause 22: The method of any one of Clauses 17-21, further comprising: generating a second interaction area; embedding a fourth code used for performing one or more of: liking, commenting, tagging, and forwarding the first media content in the second interaction area.

Clause 23: The method of any one of Clauses 17-21, wherein the specified type of related content of the second media content comprises one or more of: a segment of the second media content, a review content of the second media content, and a profile content of the second media content.

Clause 24: An apparatus for recommending related media content, comprising: a first generation module configured to generate a play area, and embed a player in the play area; a first embedding module configured to embed a first code used for obtaining a first media content and being capable of playing in the player; a second generation module configured to generate a first interaction area; and a second embedding module configured to embed a second code used for jumping to display a second media content in the first interaction area, wherein the first media content belongs to a specified type of related content of the second media content.

Clause 25: The apparatus of Clause 24, wherein the first interaction area is located inside the play area.

Clause 26: The apparatus of Clause 24, wherein the first interaction area is located outside the play area and is adjacent to the play area.

Clause 27: The apparatus of Clause 24, further comprising: a third generation module configured to generate a control area; and a third embedding module configured to embed a third code used for collecting the second media content in the control area.

Clause 28: The apparatus of Clause 27, wherein the control area is located inside the first interaction area.

Clause 29: The apparatus of any one of Clauses 24-28, further comprising: a fourth generation module configured to generate a second interaction area; and a fourth embedding module configured to embed a fourth code used for performing one or more of: liking, commenting, tagging, and forwarding the first media content in the second interaction area.

Clause 30: The apparatus of any one of Clauses 24-28, wherein the specified type of related content of the second media content includes one or more of: a segment of the second media content, a review content of the second media content, and a profile content of the second media content.

Clause 31. A non-transitory computer readable storage medium storing computer program instructions, wherein the computer program instructions, when executed by a processor, implement the method of any one of claims 17-23.

What is claimed is:

1. One or more computer readable storage media storing executable instructions that, when executed by one or more processors, cause the one or more processors to perform acts comprising:
displaying a first media content through a player;
obtaining a second media content, wherein the first media content belongs to a specified type of related content of the second media content; and
displaying a hyperlink that points to the second media content.

2. The one or more computer readable storage media of claim 1, the acts further comprising:
displaying a control used for collecting the second media content in the hyperlink.

3. The one or more computer readable storage media of claim 1, the acts further comprising:
displaying a control used for performing one or more of liking, commenting, tagging, and forwarding the first media content.

4. The one or more computer readable storage media of claim 1, wherein the specified type of related content of the second media content comprises one or more of: a segment of the second media content, a review content of the second media content, and a profile content of the second media content.

5. The one or more computer readable storage media of claim 1, further comprising displaying source and/or content information of the first media content.

6. The one or more computer readable storage media of claim 1, wherein displaying the hyperlink that points to the second media content enables jumping to display the second media content in a play interface of the specified type of related content of the second media content, without the need of a user to manually search for the second media content.

7. A method implemented by a computing device, the method comprising:
generating a play area, and embedding a player in the play area;
embedding a first code used for obtaining a first media content and being capable of playing in the player;
generating a first interaction area; and
embedding a second code used for jumping to display a second media content in the first interaction area, wherein the first media content belongs to a specified type of related content of the second media content.

8. The method of claim 7, wherein the first interaction area is located inside the play area.

9. The method of claim 7, wherein the first interaction area is located outside the play area and is adjacent to the play area.

10. The method of claim 7, further comprising:
generating a control area; and
embedding a third code used for collecting the second media content in the control area.

11. The method of claim 10, wherein the control area is located inside the first interaction area.

12. The method of claim 7, further comprising:
generating a second interaction area;
embedding a fourth code used for performing one or more of: liking, commenting, tagging, and forwarding the first media content in the second interaction area.

13. The method of claim 7, wherein the specified type of related content of the second media content comprises one or more of: a segment of the second media content, a review content of the second media content, and a profile content of the second media content.

14. An apparatus comprising:
one or more processors;
memory;
a first generation module stored in the memory and executable by the one or more processors to generate a play area, and embed a player in the play area;
a first embedding module in the memory and executable by the one or more processors to embed a first code used for obtaining a first media content and being capable of playing in the player;
a second generation module in the memory and executable by the one or more processors to generate a first interaction area; and
a second embedding module in the memory and executable by the one or more processors to embed a second code used for jumping to display a second media content in the first interaction area, wherein the first media content belongs to a specified type of related content of the second media content.

15. The apparatus of claim 14, wherein the first interaction area is located inside the play area.

16. The apparatus of claim 14, wherein the first interaction area is located outside the play area and is adjacent to the play area.

17. The apparatus of claim 14, further comprising:
a third generation module configured to generate a control area; and
a third embedding module configured to embed a third code used for collecting the second media content in the control area.

18. The apparatus of claim 17, wherein the control area is located inside the first interaction area.

19. The apparatus of claim 14, further comprising:
a fourth generation module configured to generate a second interaction area; and
a fourth embedding module configured to embed a fourth code used for performing one or more of: liking, commenting, tagging, and forwarding the first media content in the second interaction area.

20. The apparatus of claim 14, wherein the specified type of related content of the second media content includes one or more of: a segment of the second media content, a review content of the second media content, and a profile content of the second media content.
